(19) United States
(12) Patent Application Publication
(10) Pub. No.: US 2002/0130482 A1
(43) Pub. Date: Sep. 19, 2002

(54) Vehicle movable by rotating handle in a reciprocating action

(76) Inventor: Jiann Lian Jang, Tainan Hsien (TW)

Correspondence Address: CHARLES E. BAXLEY, 5th Floor, 59 John Street, New York, NY, 10038, US

(21) Appl. No.: 09/808,825

(22) Filed: Mar. 16, 2001

(51) Int. Cl. B62M 1/14

(52) U.S. Cl. 280/244; 280/87.021

(57) ABSTRACT

A vehicle includes a base having one or more wheels attached to the front portion and having a seat attached to the rear portion. A maneuvering device includes a tube rotatably engaged through the front portion of the base and includes a wheel device attached to one end and separated from the tube, and a handle device secured to the tube for rotating the wheel device of the maneuvering device in order to move the vehicle either forward or rearward. A cushioning member is engaged on the outer peripheral portion of the base for cushioning purposes.

### BACKGROUND OF THE INVENTION

1. Field of the Invention

The present invention relates to a vehicle, and more particularly to a vehicle operatable or movable by rotating the handle of the vehicle in a reciprocating action.

2. Description of the Prior Art

Typical twisting type vehicles comprise a foot support rotatably secured to the front portion of a seat and having two or more wheels attached thereto and rotatable relative to the seat to move the vehicle forward. However, the seat of the vehicle includes a tiny area or space suitable for supporting children thereon only, and may not be used for supporting adults thereon. In addition, the users have to bow their upper portion to grasp the handles that are provided on the ends of the foot support in order to move the vehicle. The riders of the vehicle may not feel comfortable.

The present invention has arisen to mitigate and/or obviate the afore-described disadvantages of the conventional twisting type vehicles.

### SUMMARY OF THE INVENTION

The primary objective of the present invention is to provide a vehicle operatable or movable by rotating the handle of the vehicle in a reciprocating action, including an elevated handle for allowing the users to comfortably rotating and operating the handle.

The other objective of the present invention is to provide a handle rotatable and movable vehicle including an elevated seat for comfortably supporting the users.

In accordance with one aspect of the invention, there is provided a vehicle comprising a base including a front portion, and including a rear portion having at least one first wheel provided thereon, a seat disposed on the rear portion of the base for supporting a user, a maneuvering device including a tube rotatably engaged through the front portion of the base and including a wheel device attached thereto and separated from the tube, and a handle device secured to the tube of the maneuvering device for rotating the wheel device of the maneuvering device in order to move the vehicle.

The base includes an outer peripheral portion, the vehicle includes a cushioning member engaged on the outer peripheral portion of the base.

The maneuvering device includes a maneuvering body having a first end and a second end, and having the tube extended from the first end thereof and having the wheel device attached to the second end thereof.

The maneuvering body includes an axle attached to the second end thereof, the wheel device includes at least two second wheels attached to the axle.

The handle device includes a handlebar stem engaged into the tube and includes a handlebar provided on the handlebar stem, the handlebar includes two ends and an opening formed between the ends of the handlebar. A device is further provided for detachably locking the handle device to the tube of the maneuvering device. The base includes a first stud extended from the rear portion thereof, the seat includes a rod extended downward therefrom and engaged in the first stud.

A device is further provided for detachably securing the rod to the first stud. One or more second studs are further provided and extended from the rear portion of the base for selectively receiving the rod of the seat. The base includes a peripheral portion, the vehicle further includes at least auxiliary wheel device attached to the peripheral portion of the base.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plane view of a vehicle in accordance with the present invention;

FIG. 2 is an exploded view of the vehicle; and

FIGS. 3 and 4 are top plane views illustrating the operation of the vehicle.

### DETAILED DESCRIPTION OF THE PREFERRED EMBODIMENT

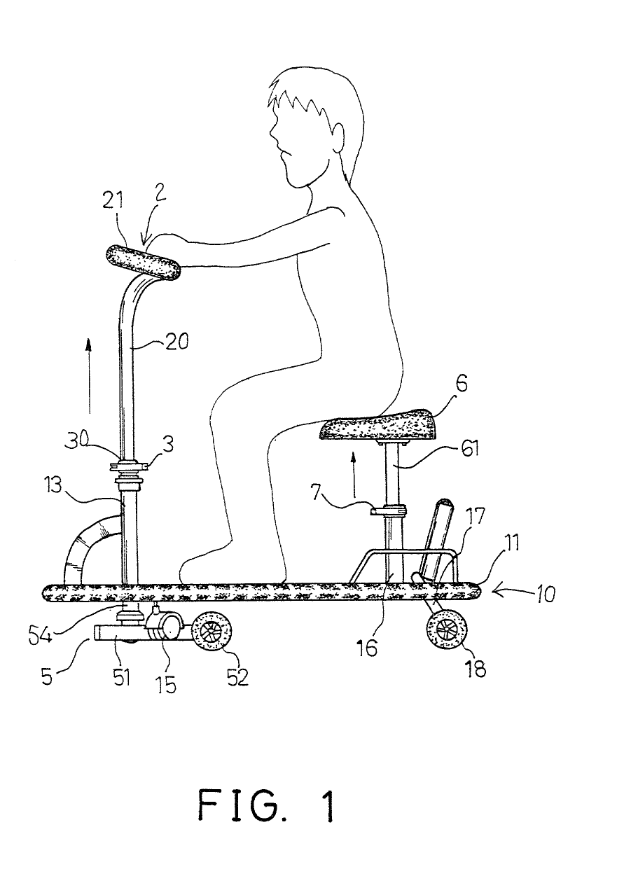

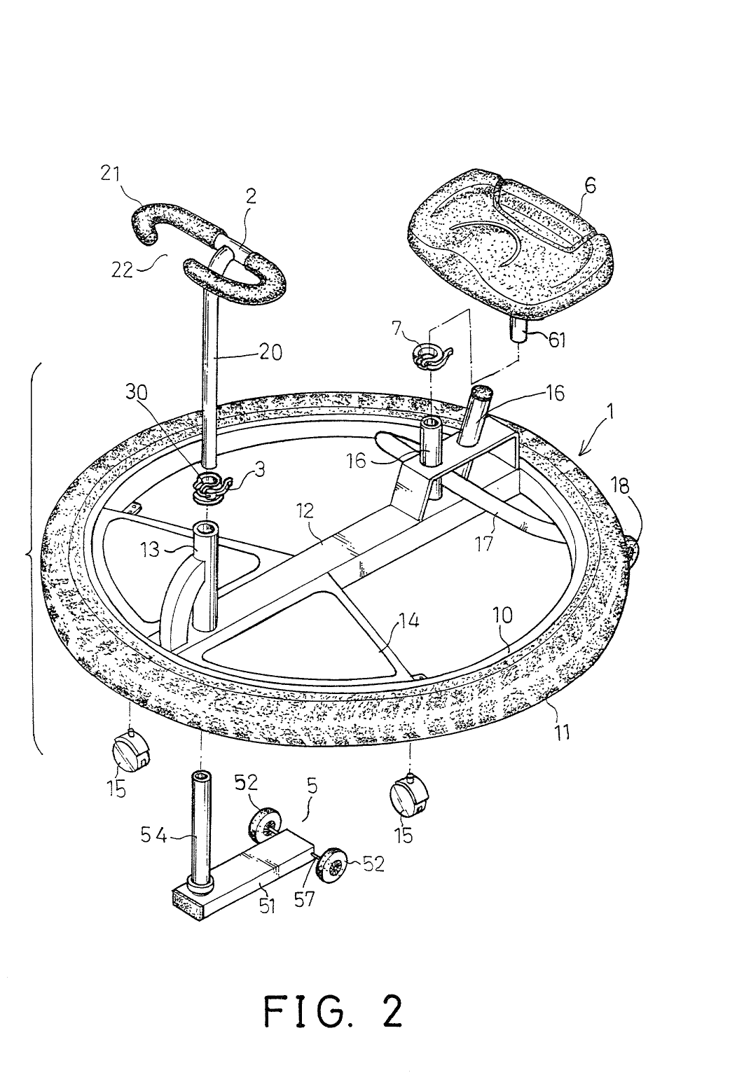

Referring to the drawings, and initially to FIGS. 1-3, a vehicle in accordance with the present invention comprises a base 1 including a peripheral or base frame 10, such as a circular frame 10, and including a resilient or cushioning member, such as a tire member 11 engaged on the outer peripheral portion of the frame 10 for absorbing the shocks or forced of the base 1 onto the other objects. The frame 10 includes a beam 12 disposed or provided in the middle portion thereof, and includes a hub 13 extended upward from the front portion thereof, such as extended upward from the front portion of the beam 12, and includes a pair of boards 14 disposed or provided in the front portion thereof for supporting the feet of the users.

A bracket 17, such as an inverted U-shaped bracket 17 is secured to the rear portion of the frame 10 and includes one or more wheels 18 attached to the bottom portion thereof. One or more auxiliary wheels 15 may further be provided and attached to the peripheral portion of the frame 10 for stabilizing purposes and for preventing the base 1 from being fall over inadvertently. The frame 10 includes one or more studs 16 provided in the rear portion thereof. A seat 6 includes a rod 61 extended downward therefrom for selectively engaging into either of the studs 16. A lock device 7, such as a quick-release lock device 7 is engaged on the rod 61 and either of the studs 16 for selectively and detachably securing the seat 6 to either of the studs 16, according to the size or the height or the weight of the users.

A maneuvering device 5 includes a maneuvering body 51 having two or more wheels 52 attached to one end thereof with an axle 57, such as to the rear portion thereof, and having a tube 54 extended upward from the front portion thereof and separated from the wheels 52 and rotatably engaged through the hub 13 of the frame 10. The wheels 18 and 52 may suitably support the base 1 in a horizontal working position. A handle device 2 includes a handlebar stem 20 extended downward therefrom and engaged into the tube 54. A securing device or a lock device 3, such as a quick-release lock device 3 includes a barrel 30 engaged on the tube 54 and the handlebar stem 20 for selectively and detachably securing the handlebar stem 20 to the tube 54 and for allowing the maneuvering device 5 to be rotated by the handle device 2. The handlebar stem 20 may be adjustably secured to the tube 54 to different heights by the lock device 3. The handle device 2 includes a handlebar 21 provided on top of the handlebar stem 20 and having an opening 22 formed in the ends of the handlebar 21.

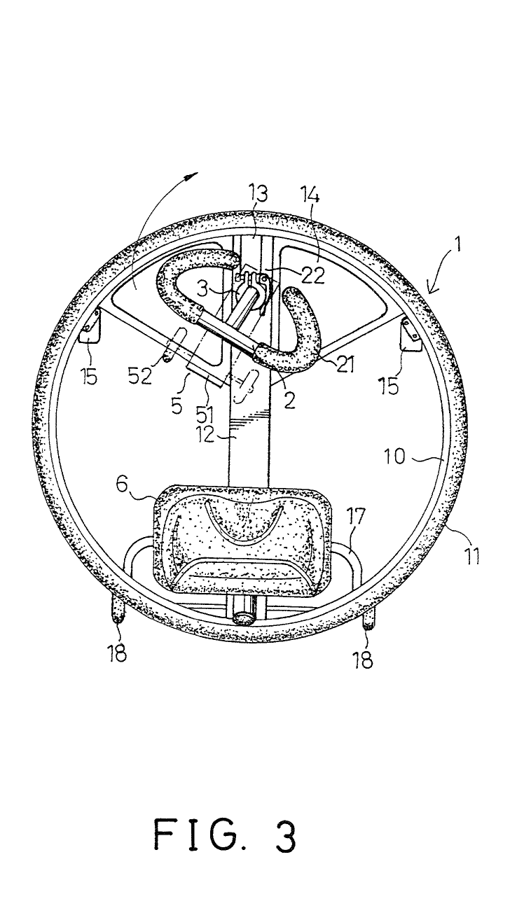

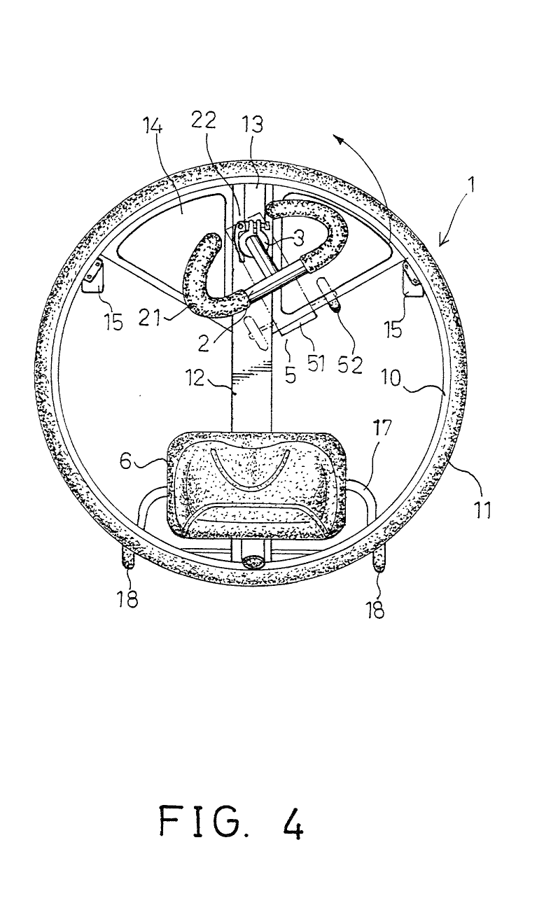

In operation, as shown in FIGS. 3 and 4, the maneuvering device 5 may be rotated in a reciprocating action by rotating the handle device 2, in order to rotate the wheels 52 rightward and leftward relative to the beam 2 of the frame 10, and in order to move the vehicle forward. When the opening 22 is faced forward, for example, the maneuvering device 5 is located in the bottom of the frame 10, the vehicle may be moved forward by rotating the handle device 2 in the reciprocating action. When the opening 22 is faced rearward, i.e., when the maneuvering device 5 is rotated outward and in front of the frame 10, for example, the vehicle may be moved rearward by rotating the handle device 2 in the reciprocating action.

Accordingly, the vehicle in accordance with the present invention may be operated or moved by rotating the handle of the vehicle in a reciprocating action, and includes an elevated handle for allowing the users to comfortably rotating and operating the handle, and/or includes an elevated seat for comfortably supporting the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A vehicle comprising:
a base including a front portion, and including a rear portion having at least one first wheel provided thereon,
a seat disposed on said rear portion of said base for supporting a user,
a maneuvering device including a tube rotatably engaged through said front portion of said base and including a wheel device attached thereto and separated from said tube, and
a handle device secured to said tube of said maneuvering device for rotating said wheel device of said maneuvering device in order to move said vehicle.

2. The vehicle according to claim 1, wherein said base includes an outer peripheral portion, said vehicle includes a cushioning member engaged on said outer peripheral portion of said base.

3. The vehicle according to claim 1, wherein said maneuvering device includes a maneuvering body having a first end and a second end, and having said tube extended from said first end thereof and having said wheel device attached to said second end thereof.

4. The vehicle according to claim 3, wherein said maneuvering body includes an axle attached to said second end thereof, said wheel device includes at least two second wheels attached to said axle.

5. The vehicle according to claim 1, wherein said handle device includes a handlebar stem engaged into said tube and includes a handlebar provided on said handlebar stem, said handlebar includes two ends and an opening formed between said ends of said handlebar.

6. The vehicle according to claim 1 further comprising means for detachably locking said handle device to said tube of said maneuvering device.

7. The vehicle according to claim 1, wherein said base includes a first stud extended from said rear portion thereof, said seat includes a rod extended downward therefrom and engaged in said first stud.

8. The vehicle according to claim 7 further comprising means for detachably securing said rod to said first stud.

9. The vehicle according to claim 7 further comprising at least one second stud extended from said rear portion of said base for selectively receiving said rod of said seat.

10. The vehicle according to claim 1, wherein said base includes a peripheral portion, said vehicle further includes at least auxiliary wheel device attached to said peripheral portion of said base.
